(19) United States
(12) Patent Application Publication
(10) Pub. No.: US 2023/0283706 A1
(43) Pub. Date: Sep. 7, 2023

(54) Device Communications Using a Human Transmission Channel

(71) Applicant: Google LLC, Mountain View, CA (US)

(72) Inventor: Alejandro Kauffmann, San Francisco, CA (US)

(73) Assignee: Google LLC, Mountain View, CA (US)

(21) Appl. No.: 17/653,104

(22) Filed: Mar. 1, 2022

(51) Int. Cl. H04M 1/72409; H04M 1/72412; G06F 3/16

(52) U.S. Cl. CPC H04M 1/724095; G06F 3/165; H04M 1/72412; G08C 23/02; H04M 2250/12

(57) ABSTRACT

This document describes techniques and apparatuses directed at device communications using a human transmission channel. In aspects, a computing device having an ultrasonic sensor is configured to receive ultrasonic signals transmitted through a physical medium associated with a user and convert the ultrasonic signal into a first electrical signal. Upon generating the first electrical signal, the computing device can execute commands included in the first electrical signal and/or transmit the commands to a network and devices wirelessly connected thereto. In so doing, the number of smart features can be reduced, and communications between computing devices can be employed using a human transmission channel without a pairing event.

### BACKGROUND

Computing devices make significant contributions to modern society, such as in the realms of safety, transportation, communication, and manufacturing. An aspect of what makes these computing devices so useful is their ability to process data, interconnect, communicate, and coordinate with each other. Due to these advantages, computing devices are increasingly implemented in a variety of ordinary objects, constituting internet-of-things (IoT) devices. Take, for instance, conventional household items like coffee makers, refrigerators, remote controls, and even toothbrushes. Such devices may be embedded with IoT technology, including software, sensors, processors, antennas, and memory, enabling an exchange of data with other devices or systems over a network connection.

Incorporating IoT technology into ordinary objects such as these can add a degree of convenience; yet, in addition to the other minimum operating features of an electronic device, the inclusion of IoT technology may increase device complexity and manufacturing costs. Moreover, setting up and/or pairing an electronic device over one or more networks may take time and prove to be difficult for a user.

### SUMMARY

This document describes techniques and apparatuses directed at device communications using a human transmission channel. In aspects, an ultrasonic sensor is disposed within a computing device, configured to receive ultrasonic signals via a physical medium associated with a user, and configured to convert the ultrasonic signal into a first electrical signal. Upon generating the first electrical signal, the computing device can execute commands included in the first electrical signal and/or transmit the commands to a network and devices wirelessly connected thereto. In so doing, the number of smart features can be reduced and communications between computing devices can be employed using a human transmission channel without a pairing event.

In aspects, a system includes a computing device and a peripheral input device. The computing device includes a first housing having a first exterior surface. The first exterior surface is in contact with a first physical medium associated with a user. In implementations, an ultrasonic sensor is disposed within the first housing configured to receive an ultrasonic signal via the first physical medium associated with the user and convert the ultrasonic signal into a first electrical signal. Further, a transmitter is disposed within the housing and operably coupled to the ultrasonic sensor, including: (i) an oscillator configured to produce a carrier signal; (ii) a modulator configured to modulate the carrier signal by imposing the first electrical signal on the carrier signal, producing a modulated carrier signal; and (iii) an antenna configured to convert the modulated carrier signal to electromagnetic waves. Additionally, a power supply is disposed within the first housing configured to distribute electrical energy to the ultrasonic sensor and the transmitter.

The peripheral input device is configured to include a contact surface in contact with a second physical medium associated with a user and be in acoustic communication with the computing device. In implementations, a plurality of ultrasonic transducers are positioned within the second housing and are configured to produce a vibration effective to generate an ultrasonic signal. The ultrasonic signal is transmissible through the contact surface and the second physical medium associated with the user for receipt by the computing device. The computing device can wirelessly transmit the electromagnetic waves to a remote device.

The details of one or more implementations are set forth in the accompanying drawings and the following description. Other features and advantages will be apparent from the description, the drawings, and the claims. This Summary is provided to introduce subject matter that is further described in the Detailed Description. Accordingly, a reader should not consider the Summary to describe essential features nor threshold the scope of the claimed subject matter.

### BRIEF DESCRIPTION OF THE DRAWINGS

The details of one or more aspects for device communications using a human transmission channel are described in this document with reference to the following drawings:

FIG. 1 illustrates an example implementation of a user attempting to unlock a locked door in accordance with one or more implementations;

FIG. 2 illustrates an example operating environment that includes an example computing device capable of implementing communications using a human transmission channel in accordance with one or more implementations;

FIG. 3 illustrates an example implementation of an ultrasonic sensor in accordance with one or more implementations;

FIG. 4 illustrates an example implementation of a transmitter and operations executed therein in accordance with one or more implementations;

FIG. 5 illustrates an example method of device communications using a human transmission channel in accordance with one or more implementations;

FIG. 6 illustrates another example method of device communications using a human transmission channel in accordance with one or more implementations;

FIG. 7 illustrates an example implementation of a peripheral input device in accordance with one or more implementations;

FIG. 8 illustrates an example environment of a physical medium associated with a user in contact with the computing device and the housing of the peripheral input device in accordance with one or more implementations;

FIG. 9 illustrates another example environment in which communication between a computing device and a peripheral input device using a human transmission channel can occur in accordance with one or more implementations; and

FIG. 10 illustrates another example environment 1000 in which communication between a computing device, a peripheral input device of an automated teller machine, and a server using a human transmission channel for at least portions can be implemented in accordance with one or more implementations.

The use of same numbers in different instances may indicate similar features or components.

### DETAILED DESCRIPTION

### Overview

Many computing devices include smart features, implemented using hardware and/or software, configured to provide connection to one or more networks, and other devices connected thereto, via any of a variety of wireless protocols. However, using such smart features can sometimes introduce some inconveniences. For instance, pairing one or more home products with smart features can take time, involving a user activating a pairing sequence for each of the devices and waiting until the connection is established. Further, electronic devices having smart features may add to software and hardware complexity, as well as increase purchasing cost or subscription fees for the user. Moreover, smart features may introduce a number of potential spoofing opportunities, as detailed below.

Consider an example scenario of a user attempting to unlock a locked door, such as when a user attempts to access an apartment. In some instances, the user may unlock the locked door by pressing buttons in a designated sequence on a keypad and open the door by turning the door handle. In fact, any person can unlock the door by pressing the buttons in the designated sequence on the keypad. This single method of authentication risks an unauthorized person discovering and entering the designated sequence to access the apartment.

In other instances, the user may set up a dual method of authentication to unlock the locked door. For example, the user may configure the keypad to receive actuation of the buttons and, in response to the actuation of the buttons being in the designated sequence, send a verification of access to one or more computing devices associated with the user. In so doing, an unauthorized user may need more than just the knowledge of the designated sequence to unlock the locked door and access the apartment. Instead, the dual method of authentication may require the unauthorized user to both know the designated sequence and obtain one of the user’s computing devices to unlock the locked door and gain access to the user’s apartment. This dual method of authentication adds layers of security to the apartment of the user, yet this too may introduce some inconveniences. For instance, in some cases, (i) all of the computing devices of the user may receive a notification of a verification of access and overwhelm the user, (ii) one or more of the computing devices of the user may need to have been previously paired to the keypad, and/or (iii) both the computing device being used to verify access and the keypad may require reliable access to a shared network as well as a reliable source of power.

In contrast, this document describes techniques and apparatuses directed at device communications using a human transmission channel. Using a human transmission channel, a user can establish a connection between two or more devices using their body, enabling communication therebetween. As a result, prior pairing between devices may not be required, easing the implementation and utilization of dual methods of authentication.

The following discussion describes operating environments, techniques that may be employed in the operating environments, and example methods. Although techniques using and apparatuses for device communications using a human transmission channel are described, it is to be understood that the subject of the appended claims is not necessarily limited to the specific features or methods described. Rather, the specific features and methods are disclosed as example implementations and reference is made to the operating environment by way of example only.

### Operating Environment

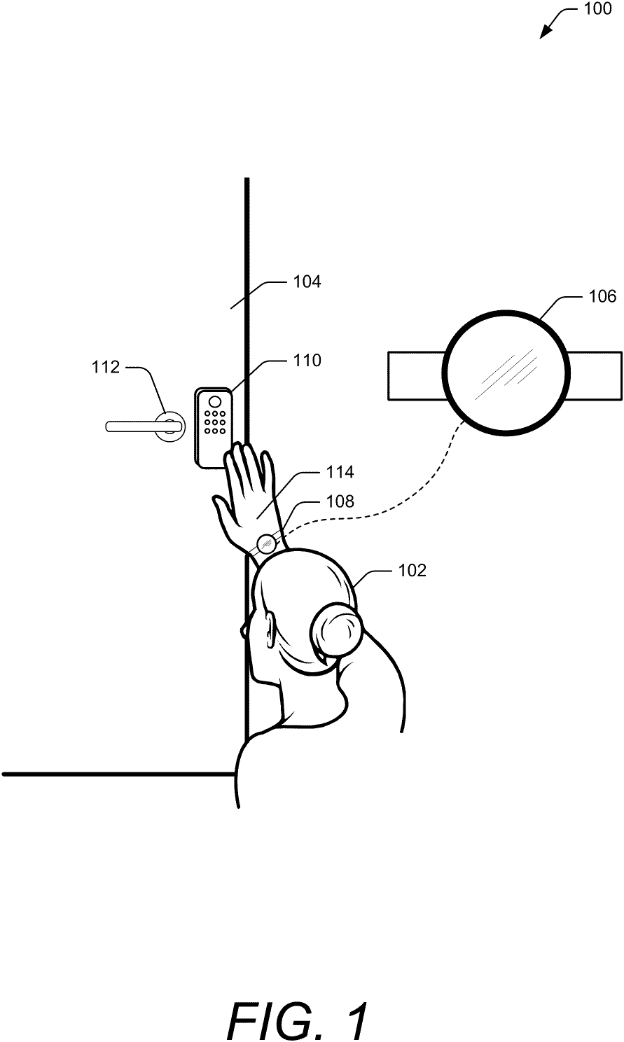

Consider now FIG. 1, which illustrates an example implementation 100 of a user 102 attempting to unlock a locked door 104 in accordance with one or more implementations. The user 102 may be attempting to unlock the locked door 104 to, for example, access an apartment. In the illustrated example, the user 102 is wearing a smartwatch 106 on the user’s wrist 108. The smartwatch 106 may be worn snuggly on the user’s wrist 108, enabling at least a portion of the smartwatch 106 to be in contact with an epidermis of the user’s wrist 108. In some implementations, the smartwatch 106 may not be in contact with the epidermis of the user’s body, but instead may be in contact with another physical medium associated with the user 102, including clothing, shoes, hair, gloves, and so forth.

In implementations, prior to the user 102 attempting to unlock the locked door, a keypad 110 may be configured having a dual method of authentication. To unlock the locked door 104, the user 102 may press buttons in a designated sequence on the keypad 110. The user 102 may then open the door 104 by turning the door handle 112. While the user 102 presses buttons on the keypad 110, the keypad 110 can produce and transmit signals (e.g., ultrasonic signals), which travel through a hand 114 and the wrist 108 of the user 102 (e.g., the epidermis) to the smartwatch 106. The smartwatch 106 may then receive the ultrasonic signals produced by the keypad 110. In this way, the hand 114 and the wrist 108 of the user 102 are used by the keypad 110 as the transmission channel by which to connect and communicate to the smartwatch 106. As a result, upon receiving the ultrasonic signals, the smartwatch 106 can confirm that the person attempting to unlock the door is an authorized user. In so doing, the two devices (e.g., the keypad 110 and the smartwatch 106) utilizing the body of the user 102 as the medium by which to transmit information adds an additional layer of security without inconveniencing the user 102.

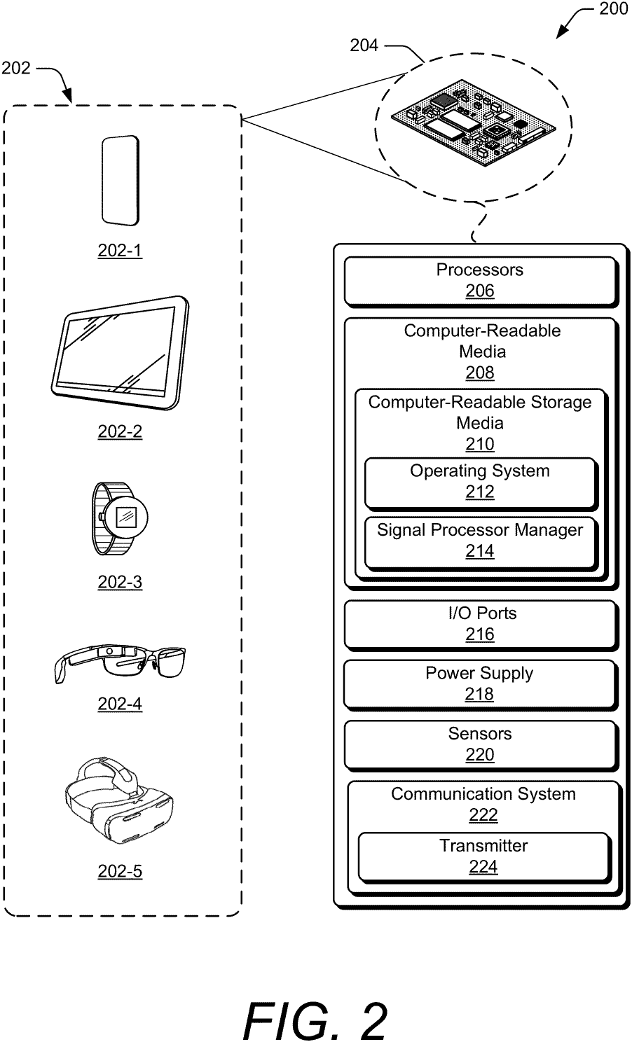

In more detail, FIG. 2 illustrates an example operating environment 200 that includes an example computing device (e.g., smartwatch 106), which is capable of implementing communications using a human transmission channel in accordance with one or more implementations. Examples of a computing device 202 include a smartphone 202-1, a tablet 202-2, a smartwatch 202-3 (e.g., the smartwatch 106), smart-glasses 202-4, and virtual-reality (VR) goggles 202-5. Although not shown, the computing device 202 may also be implemented as any of a client device, a home automation and control system, an entertainment system, a gaming console, a personal media device, a health monitoring device, a camera, an Internet home appliance capable of wireless Internet access and browsing, an IoT device, and the like. Note that the computing device 202 can be wearable, non-wearable but mobile, or relatively immobile (e.g., desktops, appliances). Further, the computing device 202, in implementations, may be an implanted device (e.g., devices that are embedded in the human body), including radiofrequency identification (RFID) microchips, near-field communication (NFC) microchips, and so forth. Note also that the computing device 202 can be used with, or embedded within, electronic devices or peripherals, such as in automobiles (e.g., steering wheels) or as an attachment to a laptop computer. The computing device 202 may include components or interfaces omitted from FIG. 2 for the sake of clarity or visual brevity.

For example, although not shown, the computing device 202 can also include a system bus, interconnect, crossbar, or data transfer system that couples the various components within the device. A system bus or interconnect can include any one or combination of different bus structures, such as a memory bus or memory controller, a peripheral bus, a universal serial bus, and/or a processor or local bus that utilizes any of a variety of bus architectures.

As illustrated, the computing device 202 includes a printed circuit board assembly 204 (PCBA 204) on which components and interconnects of the computing device 202 are embodied. Alternatively or additionally, components of the computing device 202 can be embodied on other substrates, such as flexible circuit material or other insulative material. The computing device 202 also includes a frame defining a housing having an internal cavity. The housing includes an exterior surface and an opposing interior surface. The exterior surface may include at least one portion in contact with a physical medium (e.g., hair, skin, tissue, clothing) associated with a user. For example, a smartwatch 202-3 can include an exterior surface in contact with a wrist of a user. In aspects, the housing may be any of a variety of plastics, metals, acrylics, or glasses. In an implementation, the exterior surface of the housing includes one or more channels (e.g., holes). In some implementations, the housing may include a display, an electroluminescent display (ELD), an active-matrix organic light-emitting diode display (AMOLED), a liquid crystal display (LCD), and others. Although not illustrated, various other electronic components or devices can be housed in the internal cavity of the device. Generally, electrical components and electromechanical components of the computing device 202 are assembled onto a printed circuit board (PCB) to form the PCBA 204. Various components of the PCBA 204 (e.g., processors and memories) are then programmed and tested to verify the correct function of the PCBA 204. The PCBA 204 is connected to or assembled with other parts of the computing device 202 into a housing.

As illustrated, the PCBA 204 includes one or more processors 206 and computer-readable media 208. The processors 206 may include any suitable single-core or multi-core processor (e.g., an application processor (AP), a digital-signal processor (DSP), a central processing unit (CPU), graphics processing unit (GPU)). The processors 206 may be configured to execute instructions or commands stored within computer-readable media 208. The computer-readable media 208 can include computer-readable storage media 210 having an operating system 212 and a signal processor manager 214. The computer-readable storage media 210 may include one or more non-transitory storage devices such as a random access memory (RAM, dynamic RAM (DRAM), non-volatile RAM (NVRAM), or static RAM (SRAM)), read-only memory (ROM), or flash memory), hard drive, solid-state drive (SSD), or any type of media suitable for storing electronic instructions, each coupled with a computer system bus. The term “coupled” may refer to two or more elements that are in direct contact (physically, electrically, magnetically, optically, etc.) or to two or more elements that are not in direct contact with each other, but still cooperate and/or interact with each other.

The PCBA 204 may also include input/output (I/O) ports 216. The I/O ports 216 allow the computing device 202 to interact with other devices or users, conveying any combination of digital signals, analog signals, and radiofrequency (RF) signals. The I/O ports 216 may include any combination of internal or external ports, such as universal serial bus (USB) ports, audio ports, Serial ATA (SATA) ports, peripheral component interconnect express (PCI-express) based ports or card-slots, secure digital input/output (SDIO) slots, and/or other legacy ports. Various devices may be operatively coupled with the I/O ports 216, such as human-input devices (HIDs), external computer-readable storage media, or the like.

The PCBA 204 may further include a power supply 218. In implementations, the power supply 218 includes any combination of electrical circuitry (e.g., wires, traces) and electrical components (e.g., capacitors, inductors) associated with distributing and providing electrical power to the computing device 202 and components therein. In an implementation, the power supply 218 includes a battery pack configured to store and supply electrical energy, as well as wires configured to distribute the electrical energy to components within the computing device 202. In other implementations, for example, the power supply 218 includes wiring and a USB I/O port configured to receive electrical energy from an external source and supply it to electrical components of the computing device 202.

The PCBA 204 may further include one or more sensors 220. The sensors 220 can include any of a variety of sensors, such as an audio sensor (e.g., a microphone), a touch-input sensor (e.g., a touchscreen), an image-capture device (e.g., a camera, video-camera), proximity sensors (e.g., capacitive sensors), or an ambient light sensor (e.g., photodetector).

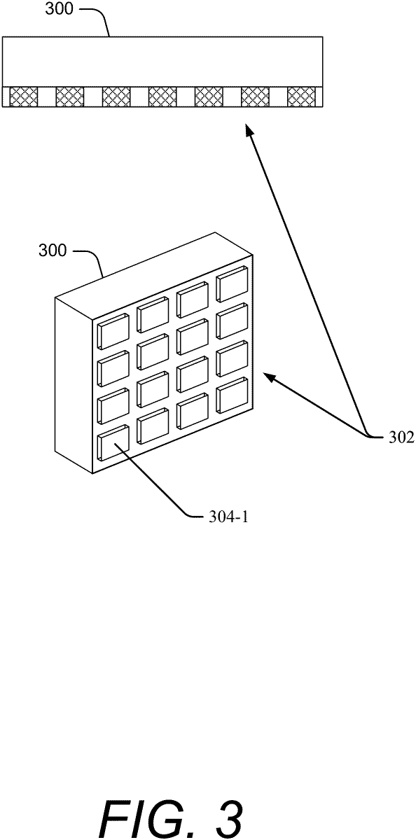

The PCBA 204 also includes one or more sensors configured to sense sound waves, including ultrasound waves. Consider FIG. 3, which illustrates an example implementation of an ultrasonic sensor in accordance with one or more implementations. As illustrated, the computing device 202 may include an ultrasonic sensor 300. The ultrasonic sensor 300 may include at least one surface (“sensing surface” 302) having ceramic crystalline material, including an array of piezoelectric elements 304. In aspects, the sensing surface 302 is configured to sense mechanical vibrations of particles within a physical medium (e.g., a human body, water, a housing of a computing device) and convert the vibrations to electrical energy, producing an electrical signal. For example, the sensing surface 302 of the ultrasonic sensor 300 can be configured to sense an ultrasonic signal propagating through a human arm. As described herein, an ultrasonic signal refers to one or more ultrasound waves containing information, including device data.

In more detail, ultrasound waves may be characterizable by waveform properties including wavelength, amplitude, frequency, speed, and direction. The ultrasound waves may generally refer to acoustic energy having a frequency above human hearing. In aspects, the ultrasonic sensor 300 may sense sound waves at frequencies exceeding 20,000 Hertz (Hz), being imperceptible to humans both tactually and audibly. In alternative implementations, or in addition thereto, the ultrasonic sensor 300 may sense sound waves at frequencies below 20,000 Hz.

In implementations, the ultrasonic sensor 300 can include additional components not illustrated in FIG. 3. For example, the ultrasonic sensor 300 can include acoustic insulation that reduces noise from undesirable sources, including from other components in the computing device 202. In further implementations, the ultrasonic sensor 300 may be mounted on the PCBA 204. In alternative implementations, the ultrasonic sensor 300 may be operably coupled to one or more electronic components on the PCBA 204 and disposed within the internal cavity proximate to the interior surface of the housing. In still further implementations, the ultrasonic sensor 300 may have a sensing surface extending through a channel in the housing, being flush with the exterior surface of the housing.

Returning to FIG. 2, the PCBA 204 may further include a communication system 222. In implementations, the communication system 222 enables communication and/or transmission of device data, including received data, transmitted data, or other data, and may provide connectivity to one or more networks and other devices connected therewith. Example communication systems include NFC transceivers, wireless personal area network (WPAN) radios compliant with various IEEE 702.15 (Bluetooth®) standards, wireless local-area network (WLAN) radios compliant with any of the various IEEE 702.11 (WiFi®) standards, WWAN (3GPP-compliant) radios for cellular telephony, wireless metropolitan area network (WMAN) radios compliant with various IEEE 702.16 (WiMAX®) standards, infrared (IR) transceivers compliant with an Infrared Data Association (IrDA) protocol, and wired local area network (LAN) Ethernet transceivers. Device data communicated over communication system 222 may be packetized or framed depending on a communication protocol or standard by which the computing device 202 is communicating. The communication system 222 may include wired interfaces, such as Ethernet or fiber-optic interfaces for communication over a local network, private network, intranet, or the Internet. Alternatively or additionally, the communication system 222 may include wireless interfaces that facilitate communication over wireless networks, such as wireless LANs, cellular networks, or WPANs.

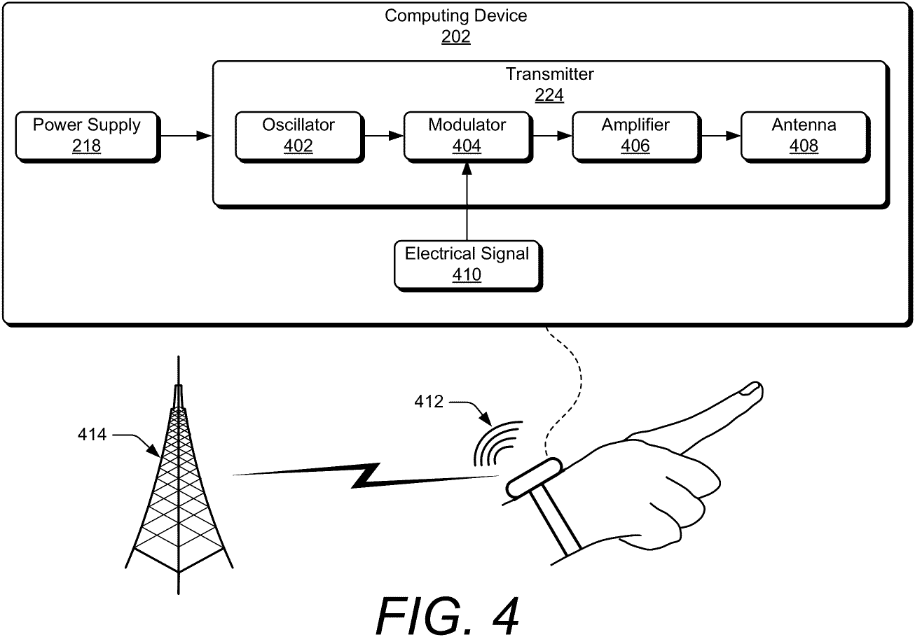

In aspects, the communication system 222 may include a transmitter 224 configured to generate and transmit electromagnetic waves carrying signals. The transmitter 224 may be disposed within the housing and communicatively coupled to the PCBA 204 and other components connected therewith. Further detail is shown in FIG. 4.

FIG. 4 illustrates an example implementation of a transmitter and operations executed therein in accordance with one or more implementations. In aspects, the transmitter 224 may include an oscillator 402, a modulator 404, an amplifier 406, and an antenna 408. The transmitter 224 and the components therein may be powered by the power supply 218.

The oscillator 402 may be configured to generate radiofrequency alternating current at a transmitting frequency, effective to produce a carrier signal. The modulator 404 may be configured to receive and modulate the carrier signal by imposing an electrical signal 410 on the carrier signal, effective to produce a modulated carrier signal. The amplifier 406 may be configured to increase the power of the modulated carrier signal, effective to expand a broadcast area. The antenna 408 may be configured to receive the modulated carrier signal and convert it to electromagnetic waves 412 (e.g., electromagnetic signals). As a result, the communication system 222 can enable communication of device data, using the electromagnetic waves 412, to one or more networks 414 and other devices connected therewith.

### Example Methods

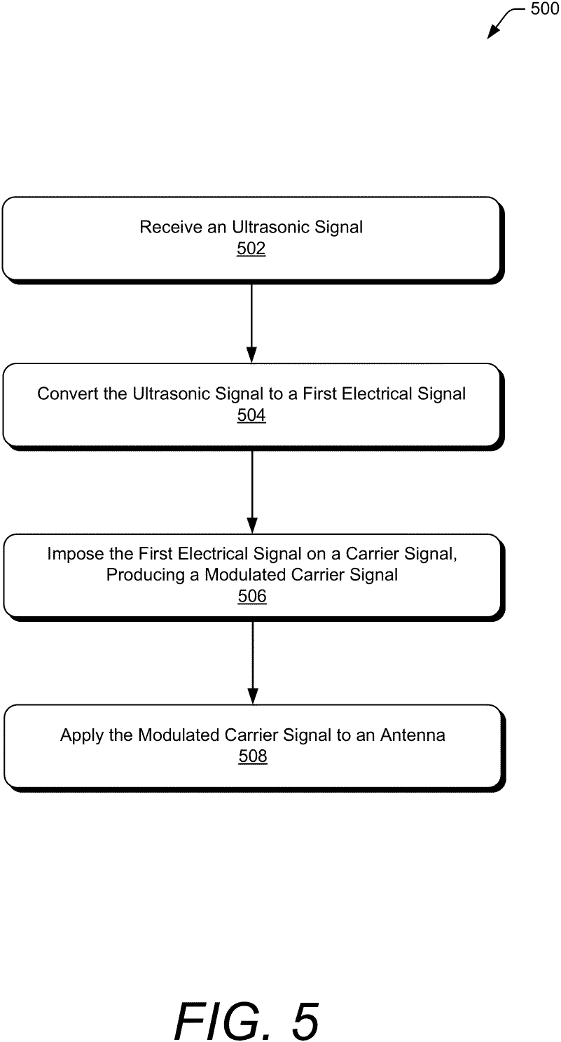

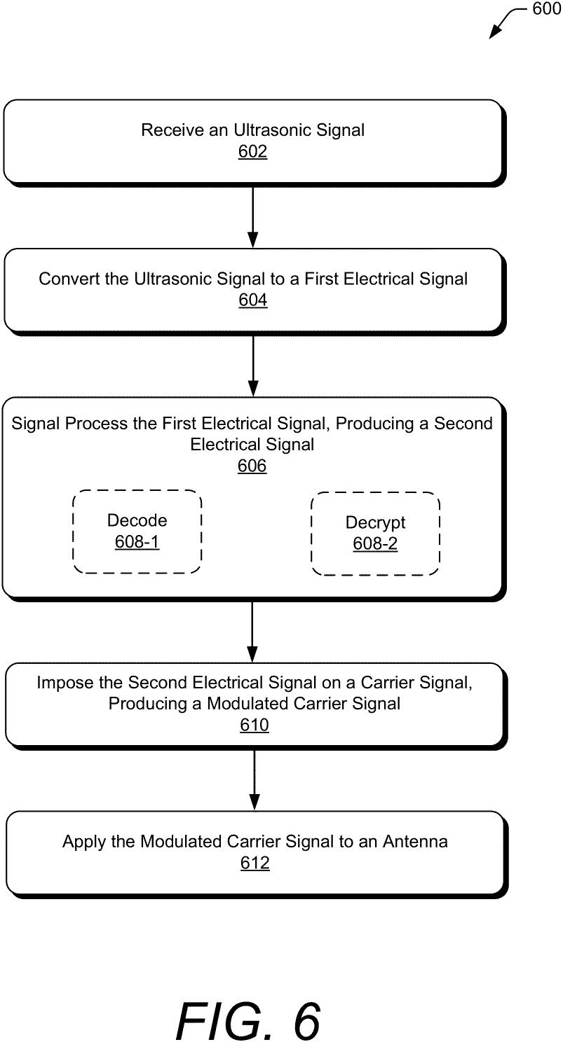

FIGS. 5 and 6 depict methods 500 and 600 enabling device communications using a human transmission channel in accordance with some implementations. These methods are shown as sets of blocks that specify operations performed but are not necessarily limited to the order or combinations shown for performing the operations by the respective blocks. In portions of the following discussion, reference may be made to operating environment 200 of FIG. 2 and entities detailed in FIGS. 3 and 4 for example only. The techniques are not limited to performance by one entity or multiple entities operating on one device.

At 502, the computing device 202 may receive an ultrasonic signal. In implementations, the computing device 202 receives the ultrasonic signal using one or more ultrasonic sensors 300. The one or more ultrasonic sensors 300 can receive the ultrasonic signal as the ultrasonic signal propagates through a medium associated with a user, including an epidermis, clothing, hair, and the like.

Upon receiving the ultrasonic signal, at 504, the ultrasonic sensor 300 may convert the ultrasonic signal to a first electrical signal (e.g., electrical signal 410). The first electrical signal may be an analog signal with a time-varying quantity including voltage. In implementations, upon acquiring the first electrical signal, or in parallel thereto, one or more processors 206 may activate the communication system 222, causing the oscillator 402 to generate radiofrequency alternating current at a transmitting frequency, effective to produce a carrier signal.

At 506, the modulator 404 may impose the first electrical signal on the carrier signal, producing a modulated carrier signal. In implementations, the amplifier 406 may amplify the modulated carrier signal.

At 508, the communication system 222 applies the modulated carrier signal to the antenna 408. As a result, the computing device 202 transmits (e.g., broadcasts) the information of the ultrasonic signal to one or more networks 414 and/or devices connected thereto as electromagnetic waves.

FIG. 6 illustrates an additional example method 600. At 602, the computing device 202 may receive an ultrasonic signal (e.g., from a device touched by a user wearing the computing device 202). In implementations, the computing device 202 receives the ultrasonic signal using one or more ultrasonic sensors 300.

Upon receiving the ultrasonic signal, at 604, the ultrasonic sensor 300 may convert the ultrasonic signal to a first electrical signal (e.g., electrical signal 410). The first electrical signal may be an analog signal with a time-varying quantity including voltage. The computing device can be configured to collect multiple ultrasonic signals simultaneously. Further, the computing device can be configured to collect more than one ultrasonic signal in a sequential fashion over a set duration before preceding further.

At 606, one or more processors 206 signal process the first electrical signal, producing a second electrical signal. Signal processing may include analyzing, denoising, boosting, modifying, and/or synthesizing the first electrical signal using any of a variety of algorithmic techniques, including machine-learned techniques. In implementations, signal processing may further include, at 608-1, decoding and/or, at 608-2, decrypting the first electrical signal. In implementations, decoding the electrical signal may involve interpreting information within the signal and, based on the interpretation, producing a second electrical signal having relevant information to the first electrical signal. For example, the first electrical signal can be encoded in the American Standard Code for Information (ASCII) and the one or more processors 206 may be configured to decode the first electrical signal. In implementations, decrypting the first electrical signal can involve using digital signatures. For example, within a digital signature scheme, the first electrical signal can be encrypted with a public key and the one or more processors 206 can be configured to decrypt the first electrical signal using a corresponding private key.

In implementations, upon acquiring the second electrical signal, or in parallel thereto, one or more processors 206 may activate the communication system 222, causing the oscillator 402 to generate radiofrequency alternating current at a transmitting frequency, effective to produce a carrier signal. At 610, the modulator 404 may impose the second electrical signal on the carrier signal, producing a modulated carrier signal. In implementations, the amplifier 406 may amplify the modulated carrier signal.

At 612, the communication system 222 applies the modulated carrier signal to the antenna 408. As a result, the computing device 202 transmits (e.g., broadcasts) the information of the ultrasonic signal via the network 414 for reception by another device (e.g., the device that generated the ultrasonic signal when touched by the user 102, a device associated with a lock).

### Example Implementations

In portions of the following discussion, reference may be made to the example implementation 100 of FIG. 1, operating environment 200 of FIG. 2, and entities detailed in FIGS. 3 and 4 for example only.

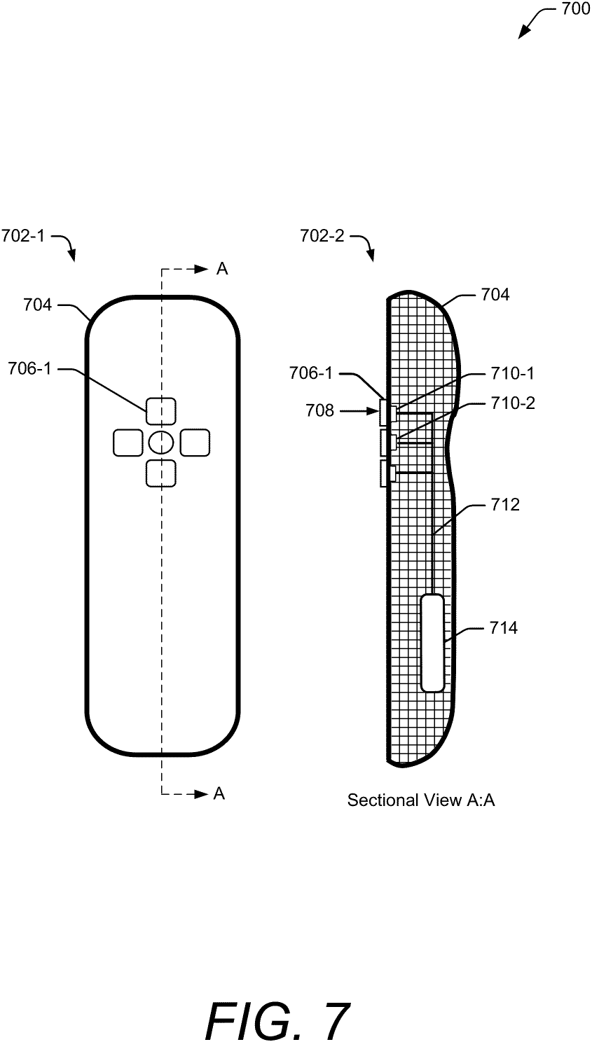

FIG. 7 illustrates an example implementation 700 of a peripheral input device 702 in accordance with one or more implementations. As illustrated, FIG. 7 depicts a front view of the peripheral input device 702-1 and a sectional view of the peripheral input device 702-2, taken along line A-A. The peripheral input device 702 may be any device having a housing 704 configured to transmit data, including ultrasonic signals, to the computing device 202. In aspects, the peripheral input device 702 includes one or more ultrasonic transducers configured to transmit ultrasonic signals to the computing device 202.

The housing 704, as illustrated in FIG. 7, may have an exterior surface and an opposing interior surface, defining an internal cavity. The housing 704 may define any of a variety of three-dimensional polyhedral shapes, including substantially rectangular or cylindrical shapes. As non-limiting examples, the housing may be composed of any combination of plastic, foam, glass, metal, and so forth. Additionally, one or more sections may form the housing, including a plastic backplate, a glass display, silicone rubber buttons, and others, each having an exterior contact surface (“contact surface”) configured to come in contact (e.g., touched, pressed) with at least portions of a user (e.g., finger, hand, arm), as well as portions associated with a user (e.g., clothing, shoes). In one example, the housing 704 includes a metal frame and push buttons 706, each having a contact surface. In another example, not illustrated, the housing includes a glass display and an aluminum frame, each having a contact surface.

In the example shown in FIG. 7, the peripheral input device 702 includes an acrylic frame and multiple push buttons 706 each having a contact surface and forming the housing 704 of the peripheral input device 702. A push button (e.g., push button 706-1) may be configured to depress when a user applies a compressive force substantially perpendicular to a top of the contact surface 708 of the given push button. For example, push button 706-1 is configured to have two states: (i) an elevated state; and (ii) a depressed state. The top contact surface 708 of the push button 706-1 in the elevated state may be configured to rise in a range from 0 millimeters (mm) to 10 mm above the contact surface of the acrylic frame. For example, in the elevated state, the top contact surface 708 of the push button 706-1 rises 7 mm above the contact surface of the acrylic frame. The top contact surface 708 of the push button 706-1 in the depressed state may be configured to depress 5 mm to 10 mm below the top contact surface 708 of the push button 706-1 in the elevated state. For example, in the depressed state, the top contact surface 708 of the push button 706-1 is flush with the contact surface defined by the acrylic frame, being depressed 7 mm from the elevated state. In implementations, the push button may be configured as having two states using a spring that compresses and expands with a predetermined spring constant. In alternative implementations, a pressure-sensitive adhesive may be used to implement a push button having an elevated state and a depressed state. When a push button (e.g., push button 706-1) is pressed by a user into a depressed state, the push button may activate (e.g., actuate) one or more ultrasonic transducers 710.

As illustrated in FIG. 7, the peripheral input device 702 includes five push buttons 706. In aspects, ultrasonic transducers 710 are disposed within the housing 704 underneath one or more of the push buttons 706. In an implementation, the ultrasonic transducers 710 are disposed adjacent to an interior surface of the push buttons 706.

In aspects, the ultrasonic transducers 710 may be configured to generate high-frequency vibrations effective to transmit ultrasound waves. As an example, a fluctuating electric current may be applied to an ultrasonic transducer 710-1 causing piezoelectric elements within the ultrasonic transducer 710-1 to fluctuate in shape effective to produce mechanical vibrations (e.g., ultrasound waves). In portions of the following description, the ultrasound waves produced by the ultrasonic transducers 710 include information and are thus referred to as ultrasonic signals. In implementations, more than one ultrasonic transducer (e.g., ultrasonic transducer 710-1) may be implemented within the peripheral input device 702. Further, piezoelectric elements within each of the ultrasonic transducers 710 may be configured having unique electromechanical properties, effective to produce unique ultrasonic signals from another ultrasonic transducer in the peripheral input device 702. For example, two ultrasonic transducers may be implemented in the peripheral input device 702. Piezoelectric elements of a first ultrasonic transducer may be configured to generate ultrasonic signals at, for example, 3 megahertz (MHz), while piezoelectric elements of a second ultrasonic transducer may be configured to generate ultrasonic signals at, for example, 7 MHz.

An ultrasonic transducer can further include acoustic insulation, enabling noise reduction from undesirable sources, including other components in the peripheral input device 702. An ultrasonic transducer can also include a backing layer that suppresses vibrations of the piezoelectric elements, allowing ultrasonic signals to be produced in shorter pulses. On a side opposite the backing layer, and the piezoelectric elements therebetween, a matching layer may be disposed being configured to reduce a difference in impedance (e.g., an impedance delta) between the piezoelectric elements and a medium associated with a user (e.g., tissue). In so doing, a reflection of ultrasonic signals caused by a potentially high impedance can be minimized. An ultrasonic transducer may further include an acoustic lens. The acoustic lens may be implemented as an insulating material (e.g., rubber) that focuses ultrasound signals, thereby reducing a scattering of ultrasonic signals.

In implementations, an ultrasonic transducer (e.g., ultrasonic transducer 710-1) may be configured to activate when a push button (e.g., push button 706-1), coupled to the ultrasonic transducer, is pressed by a user into a depressed state. As described herein, an ultrasonic transducer that activates when a push button, coupled to the ultrasonic transducer, is in a depressed state is referred to as an associated ultrasonic transducer. In an example, the top contact surface 708 of the push button 706-1 starts in an elevated state 7 mm above the contact surface of the acrylic frame. When a user applies a compressive force substantially perpendicular to the top contact surface 708 of the push button 706-1 by pressing the push button 706-1 with a finger, a spring, for instance, compresses 7 mm allowing the push button 706 to be in a depressed state. When in the depressed state, the push button 706-1 activates the ultrasonic transducer 710-1. Activation of an ultrasonic transducer (e.g., ultrasonic transducer 710-1) may involve a push button (e.g., push button 706-1) completing an electrical circuit 712, which may function essentially as a manual switch. The electrical circuit 712 may also include a battery 714 configured to supply power to the ultrasonic transducers 710. In such an implementation, the ultrasonic transducers 710 may be wired in an electrically parallel configuration. As a result, when a push button is in the depressed state, only the associated ultrasonic transducer is activated.

In implementations, the electrical circuit 712 may further include other circuit components, including resistors, inductors, capacitors, and so forth. The electrical circuit 712 may also be configured to supply varying electrical signals to each of the ultrasonic transducers 710 using one or more circuit components. In so doing, each of the ultrasonic transducers 710 can receive varying electrical signals effective to generate high-frequency vibrations producing differing ultrasonic signals. The ultrasonic signals may differ in frequency, amplitude, phase, and so forth.

As an example, in response to a user pressing the push button 706-1 to the depressed state, the push button 706-1 may close the electrical circuit 712. In a closed state, the electrical circuit 712 may distribute electrical energy from the battery 714 through various electronic components, producing a fluctuating electric current received by the associated ultrasonic transducer 710-1. The fluctuating electric current may cause piezoelectric elements in the ultrasonic transducer 710-1 to fluctuate in shape effective to produce mechanical vibrations (e.g., an ultrasonic signal). In so doing, a first ultrasonic transducer (e.g., the ultrasonic transducer 710-1) may receive an electric current causing piezoelectric elements to produce an ultrasonic signal with a frequency of 3 MHz, while a second ultrasonic transducer (e.g., the ultrasonic transducer 710-2) may receive an electric current causing piezoelectric elements to produce an ultrasonic signal with a frequency of 7 MHz.

In an alternative implementation, or in addition thereto, piezoelectric elements within ultrasonic transducers 710 may have unique electromechanical properties differing from one another. In so doing, the ultrasonic transducers 710 may receive a similar fluctuating electric current and produce differing ultrasonic signals.

In some implementations, the peripheral input device 702 further includes a processor (e.g., a CPU) and computer-readable storage media having instructions. The processor may be operably coupled to each of the ultrasonic transducers 710 and the battery 714. In such an implementation, when a user presses a push button (e.g., push button 706-1) to the depressed state, the processor may determine which push button 706 was pressed and execute corresponding instructions stored in the computer-readable storage media. Execution of the instructions may cause the processor to produce an electrical signal having encoded information (e.g., ASCII values, Morse code, Murray code, international codes, Unicode). The electrical signal having encoded information may then be transmitted to an associated ultrasonic transducer 710-1, causing the associated ultrasonic transducer 710-1 to produce an ultrasonic signal. The instructions may further direct the processor to produce electrical signals having encoded information that differs based on which push button was pressed. In further implementations, the encoded information can be encrypted using a cryptographic algorithm, including hash functions (e.g., Secure Hash Algorithm (SHA)-2), asymmetric algorithms, and symmetric algorithms.

In another example, the peripheral input device 702 may utilize any of a variety of input mechanisms, including touchpads, resistive touch screens, capacitive touch panels, surface acoustic wave (SAW) touch panels, optical touch panels, electromagnetic induction touch panels, pen-based input, squeeze gestures, and others, effective to activate an ultrasonic transducer to produce an ultrasonic signal. For example, upon a user touching a touch screen, a processor may receive the touch input and activate an ultrasonic transducer. In another example, upon a user implementing commands on a trackpad, a processor may receive the commands and activate an ultrasonic transducer.

In one example, a peripheral input device may include a single ultrasonic transducer configured to activate for one or more input mechanisms. For example, the single ultrasonic transducer can be activated by a squeeze gesture applied to a housing of a peripheral input device 702. Further, a processor may be configured to send the ultrasonic transducer differing electrical signals based on a type of command (e.g., different push buttons pressed) and/or the input mechanism (e.g., a squeeze gesture, a push button).

In another example, the peripheral input device 702 does not include any of a battery 714, power supply, or electrical circuit 712, not having any electrical power whatsoever. In aspects, the one or more ultrasonic transducers are configured to activate and generate ultrasonic signals from a user input (e.g., a compressive force, a swipe gesture, a rolling), including a force associated with the user input. For example, mechanical energy from a compressive force applied by a user on the push button 706-1 can be converted to electrical energy using electromagnetic induction or piezoelectric elements (e.g., materials that can convert mechanical stress to electric charge), effective to activate the ultrasonic transducer. In another example, using the mechanical force of the user input on a push button 706-1, an associated ultrasonic transducer 710-1 may be mechanically configured to generate the ultrasonic signal. Further, the peripheral input device 702 may not include a transmitter (e.g., a radiofrequency transmitter, an optical transmitter), and yet the peripheral input device 702 may still communicate device data using ultrasonic transducers 710. In such an implementation, the peripheral input device 702 reduces the number of electronic components, minimizing device complexity and costs.

Generally, any of the components, modules, and operations described herein can be implemented using software, firmware, hardware, (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, including, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Device (CPLDs), and the like.

In portions of the following discussion, reference may be made to the example implementation 100 of FIG. 1, operating environment 200 of FIG. 2, and entities detailed in FIGS. 3, 4, and 7 for example only.

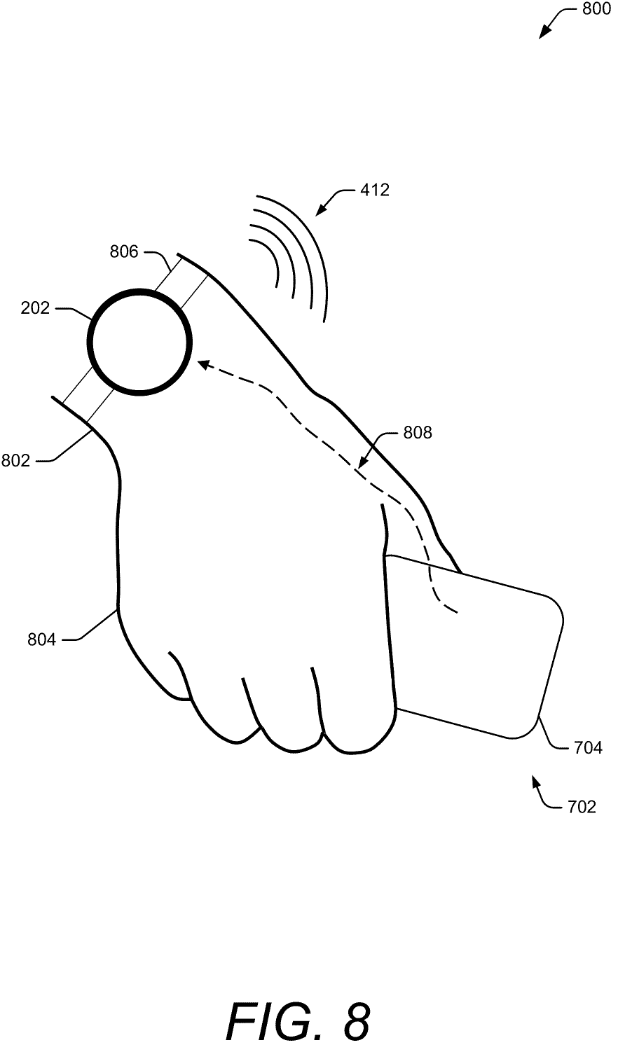

FIG. 8 illustrates an example environment 800 of a physical medium associated with a user in contact with the computing device 202 and the housing 704 of the peripheral input device 702 in accordance with one or more implementations. In the illustrated example, a user is wearing a smartwatch (e.g., smartwatch 202-3) on a wrist 802 while holding in a hand 804 the peripheral input device 702 (e.g., a remote control). The smartwatch may be held snuggly to the user’s wrist 802 via a band 806. In aspects, the smartwatch includes a communication system (e.g., communication system 222) enabling communication of device data, using electromagnetic waves (e.g., electromagnetic waves 412).

In aspects, one or more ultrasonic transducers (e.g., ultrasonic transducers 710) of the peripheral input device 702 generate an ultrasonic signal 808. Using the human body as the transmission channel, the ultrasonic signal 808 passes through the hand 804 to the smartwatch. The ultrasonic signal 808 may propagate at frequencies exceeding 20,000 Hz, being imperceptible to the user both tactually and audibly. One or more ultrasonic sensors (e.g., ultrasonic sensor 300) of the smartwatch may receive the ultrasonic signal 808.

Upon receiving the ultrasonic signal 808, the one or more ultrasonic sensors may convert the ultrasonic signal to a first electrical signal. In implementations, upon acquiring the first electrical signal, or in parallel thereto, one or more processors (e.g., processors 206) activate the communication system, causing an oscillator (e.g., oscillator 402) to generate radiofrequency alternating current at a transmitting frequency, effective to produce a carrier signal. A modulator (e.g., modulator 404) may impose the first electrical signal on the carrier signal, producing a modulated carrier signal. In implementations, an amplifier (e.g., amplifier 406) may amplify the modulated carrier signal. Then the communication system may apply the modulated carrier signal to an antenna (e.g., antenna 408). As a result, the computing device can transmit (e.g., broadcast) the device data of the peripheral input device 702 included in the ultrasonic signal 808.

As an example, the user uses their thumb to press push button 706-1 (from FIG. 7), which corresponds to the numerical value of one. The compressive force of the pressing action applied by the user on the push button causes the push button to depress, effective to activate the associated ultrasonic transducer 710-1 (from FIG. 7) without electrical energy supplied by an electrical power distributor (e.g., battery 714, electrical circuit 712). Activating the associated ultrasonic transducer 710-1 generates an ultrasonic signal 808 having a waveform, for example, with a frequency of 1 MHz, a signal duration of two milliseconds, and a low amplitude (e.g., 0.01 watts per meter squared). Specific waveform properties of the ultrasonic signal 808, including the frequency, may correspond to a value of the pressed push button. In other implementations, a value of a pressed push button is directly encoded in the ultrasonic signal 808.

The ultrasonic signal 808 may pass through the hand 804 of the user to the ultrasonic sensor 300 in the smartwatch 202-1. The ultrasonic sensor 300 in the smartwatch 202-1 may then convert the ultrasonic signal 808 to a first electrical signal and transmit the first electrical signal to the communication system 222 (from FIG. 2) within the smartwatch 202-1. In aspects, the communication system 222 imposes the first electrical signal directly into a carrier wave without processing (e.g., decoding, decrypting) the first electrical signal. Using the antenna 408, the smartwatch 202-1 can transmit device data of the peripheral input device as electromagnetic waves 412 to one or more networks 414 and/or devices connected thereto.

In implementations, a remote device (e.g., a television, a server) may receive the electromagnetic waves 412 using a receiver. The receiver may include one or more of a circuit board, an antenna, electronic filters, amplifiers, and other electronic components. The receiver may convert the electromagnetic waves 412 to an electrical signal containing data, including, for example, the device data of the peripheral input device (e.g., instructions to turn down the volume, a command to power a display of the remote device). The antenna may then transmit the electrical signal containing the device data of the peripheral input device 702 to a processor. The processor may then analyze the device data in the electrical signal. Analysis can include determining a noise level in the electrical signal. If the noise level exceeds a threshold value, then the processor may denoise the electrical signal. Further, the remote device may use the device data contained in the electrical signal to implement a command, including inputting the numerical value (e.g., one, two, three). In another implementation, one or more processors in either the computing device 202 or the remote device may process (e.g., decode, decrypt) and/or modify any of the signals, including the ultrasonic signal 808, the first electrical signal, and the electrical signal containing the device data.

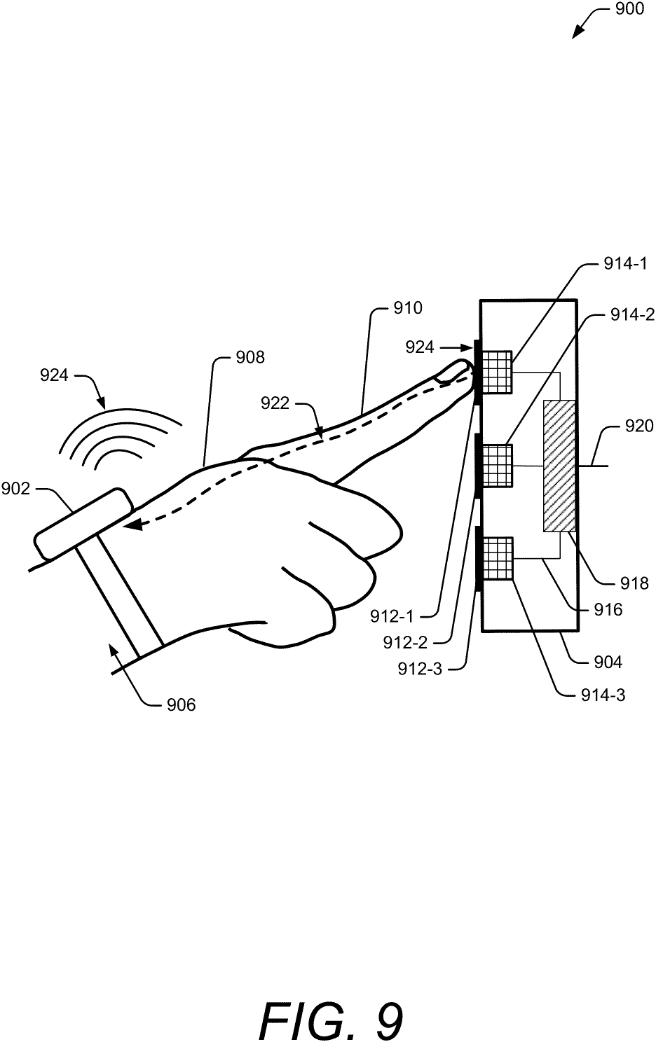

FIG. 9 illustrates another example environment 900 in which communication between a computing device (smartwatch 902) and a peripheral input device 904 using a human transmission channel can be implemented in accordance with one or more implementations. As illustrated, a physical medium associated with a user, including a wrist 906 of the user’s hand 908, is in contact with the smartwatch 902. In addition, a finger 910 of the user’s hand 908, is in contact with at least one contact surface, such as an exterior surface of push button 912-1.

The peripheral input device 104 may include any of a variety of contact surfaces, including exterior surfaces of one or more push buttons, housings, actuators, touchscreens, touchpads, and the like, through which ultrasonic signals can be transmitted. The peripheral input device 904 can be implemented, as non-limiting examples, as an automated teller machine, a doorbell, a callbox, a personal identification number (PIN) pad, a door lock, and so forth.

In the illustrated example, the peripheral input device 904 includes a keypad having multiple push buttons 912 (e.g., push button 912-2, push button 912-3). One or more of the push buttons 912 may be configured to have two states: an elevated state and a depressed state. For example, push button 912-1 may include a spring (not illustrated) configured to extend the push button 912-1 to the elevated state and enable the push button 912-1 to depress to the depressed state when acted on by a compressive force (e.g., finger press). Further, each of the push buttons 912 are communicatively coupled to an ultrasonic transducer 914 (e.g., ultrasonic transducer 914-1, ultrasonic transducer 914-2, ultrasonic transducer 914-3). The ultrasonic transducers 914 are disposed within the housing of the peripheral input device 904 beneath (e.g., adjacent) each of the push buttons 912. For example, an ultrasonic transducer 914-1 is disposed beneath the push button 912-1, an ultrasonic transducer 914-2 is disposed beneath the push button 912-2, and an ultrasonic transducer 914-3 is disposed beneath the push button 912-3. Each of the ultrasonic transducers 914 may be communicatively coupled to the push buttons 912.

In another example (not illustrated), each of the push buttons 912 are communicatively coupled to a single ultrasonic transducer. The single ultrasonic transducer may be configured to produce varying ultrasonic signals. In such a configuration, the ultrasonic transducer can be configured to produce an ultrasonic signal 922 corresponding to any of the push buttons 914 pressed by the user.

As illustrated, the peripheral input device 904 further includes, or is operably coupled to, electrical circuitry 916 (e.g., wiring, resistors, capacitors), at least one processor 918, and an external power supply 920. The electrical circuitry 916 operably couples the processor 918 to each of the ultrasonic transducers 914. The external power supply 920 may be implemented as a power cord, connecting the peripheral input device 904 to a mains electricity supply.

In such an example, when a user applies a compressive force to a top surface (e.g., contact surface 924) of the push button 912-1 and presses the push button 912-1 from the elevated state to the depressed state, the processor 918 registers the push button 912-1 as being actuated. Any of a variety of mechanisms may be utilized to enable the processor 918 to register the push button 912-1 as being actuated, including switch mechanisms, piezoelectric actuators, and so forth. In response to the processors 918 registering actuation of the push button 912-1, the processor 918 generates a fluctuating electric current, activates the associated ultrasonic transducer 914-1, and causes the associated ultrasonic transducer 914-1 to produce an ultrasonic signal 922 corresponding to (e.g., representing) the push button 912-1 pressed by the user.

In one example, the processor 918 can register the push button 912-1 pressed by the user as being a push button that directs the peripheral input device 904 to input data (e.g., input the value one) or a command (e.g., an enter button). Responsive to the push button 912-1 being pressed, the processor 918 of the peripheral input device 904 can implement, for example, a public-key cryptography scheme (e.g., asymmetric cryptography) to encrypt signature-related data (“encrypted data”). The processor 918 may then transmit an electrical signal including the encrypted data to the ultrasonic transducer 914-1, effective to produce an ultrasonic signal 918 including the encrypted data.

In some examples, the peripheral input device 904 may be electrically unpowered. The peripheral input device 904 neither receives electrical power from an external source, nor has electrical components (e.g., one or more batteries) configured to power components therein. Further, the peripheral input device 904 may exclude the electrical circuitry 916 and the processor 918. In an additional or alternative example (not illustrated), the peripheral input device 904 may utilize the compressive force of a pressing action applied by the user to generate an ultrasonic signal 922. For instance, when the user presses push button 912-1 with their finger 910, the compressive force induced by the pressing action on the push button 912-1 causes the push button 912-1 to depress from the elevated state to the depressed state, activating the ultrasonic transducer 914-1. Activation of the ultrasonic transducer 914-1 may, as a non-limiting example, be implemented using piezoelectric elements. For example, pressing the push button 912-1 to the depressed states causes piezoelectric elements in the ultrasonic transducer 914-1 to mechanically deform and, as a result, produce an electric charge. The ultrasonic transducer may use the electric charge to produce the ultrasonic signal 922. In another example, pressing the push button 912-1 to the depressed states causes a clicking mechanism to produce the ultrasonic signal 922.

In further examples, the ultrasonic transducer 914-1 may be configured to produce the ultrasonic signal 922 at any point after the push button 912-1 has been pressed to the depressed state (e.g., released). For example, upon the user reducing the compressive force applied by their finger 910 on the push button 912-1, the ultrasonic transducer 914-1 is configured to produce the ultrasonic signal 922.

The ultrasonic signal 922 may include data (e.g., information, commands, instructions, characteristics, parameters) representative of a value or identity of the push button 912-1 pressed, such as a numerical or alphanumerical value. For example, a numerical value, such as the number one, may be printed on (or etched, adhered, or formed in braille) the top contact surface 924 of the push button 912-1. The resultant ultrasonic signal 922 produced by the user pressing the push button 912-1 includes data corresponding to (e.g., representative of) the numerical value of one. As an example, a characteristic (e.g., frequency) of the ultrasonic signal 922 may be representative of the numerical value of the push button (e.g., one). In another example, information may be encoded into the ultrasonic signal 922 representative of the numerical value of one. In still another example, the numerical value of one may be encrypted in the ultrasonic signal 922. Each of the ultrasonic transducers 914 can be configured to produce ultrasonic signals 922 including data corresponding to their respective push button 912.

The ultrasonic signal 922 can be mechanically transmitted through the push button 912-1 and the hand 908 of the user to the smartwatch 902. In some examples, the user may not be wearing the smartwatch 902 but may be carrying another computing device 202, including a smartphone 202-1. For example, the user may be holding the smartphone 202-1 in a second hand (not illustrated). In such an example, the ultrasonic signal 922 can pass through the user’s body from the hand 908 pressing the push button 912-1 to the second hand holding the smartphone 202-1. In another example, the user may be carrying the smartphone 202-1 in a clothing article, including a pocket. In such an example, the ultrasonic signal 922 can be transmitted through two mediums associated with the user, including the body of the user and a fabric cloth covering the epidermis of the user. In still another example, the user may be wearing a glove on their hand 908 while the smartwatch 902 is in contact with their wrist 906. In such an example, the ultrasonic signal 922 can be transmitted through two mediums associated with the user, including a fabric cloth covering the epidermis of the user and the hand 908 of the user.

The smartwatch 902 can receive the ultrasonic signal 922 using an ultrasonic sensor (not illustrated), causing the ultrasonic sensor (e.g., ultrasonic sensor 300) to produce a first electrical signal (e.g., electrical signal 410). In so doing, the peripheral input device 904 and the smartwatch 902 may be in acoustic communication with one another, utilizing the user as the transmission channel. The first electrical signal may be signal processed by a processor in the smartwatch 902. Signal processing may include denoising, decoding, decrypting, analog-to-digital conversion, data compression, automatic gain control, acoustic echo cancellation (AEC), filtering, resampling, equalization, beamforming, and the such. Resultant to the signal processing, a second electrical signal may be produced. Upon producing the second electrical signal, the smartwatch 902 may perform, implement, and/or transmit data (e.g., commands, instructions, information, characteristics, parameters) contained in the second electrical signal.

In additional or alternative examples, the first electrical signal may not be signal processed. Instead, the smartwatch 902 may directly perform, implement, and/or transmit data contained in, or associated with, the first electrical signal, including characteristics and/or parameters of the first electrical signal.

In an example, the data may include instructions to authenticate an identity of the user using one or more biometric systems. Through such a technique, users can authenticate their identity without, for example, the use of a card (e.g., an identification card, a credit card), passwords, or other identity data.

In additional or alternative implementations, upon receiving the first electrical signal and/or producing the second electrical signal, or in parallel thereto, the processor activates the communication system, causing an oscillator (e.g., oscillator 402) to generate radiofrequency alternating current at a transmitting frequency, effective to produce a carrier signal. A modulator (e.g., modulator 404) may impose the second electrical signal on the carrier signal, producing a modulated carrier signal. In implementations, an amplifier (e.g., amplifier 406) may amplify the modulated carrier signal. Then the communication system may apply the modulated carrier signal to an antenna (e.g., antenna 408). As a result, the computing device can transmit (e.g., broadcast) device data or data regarding the ultrasonic signal as electromagnetic waves 924.

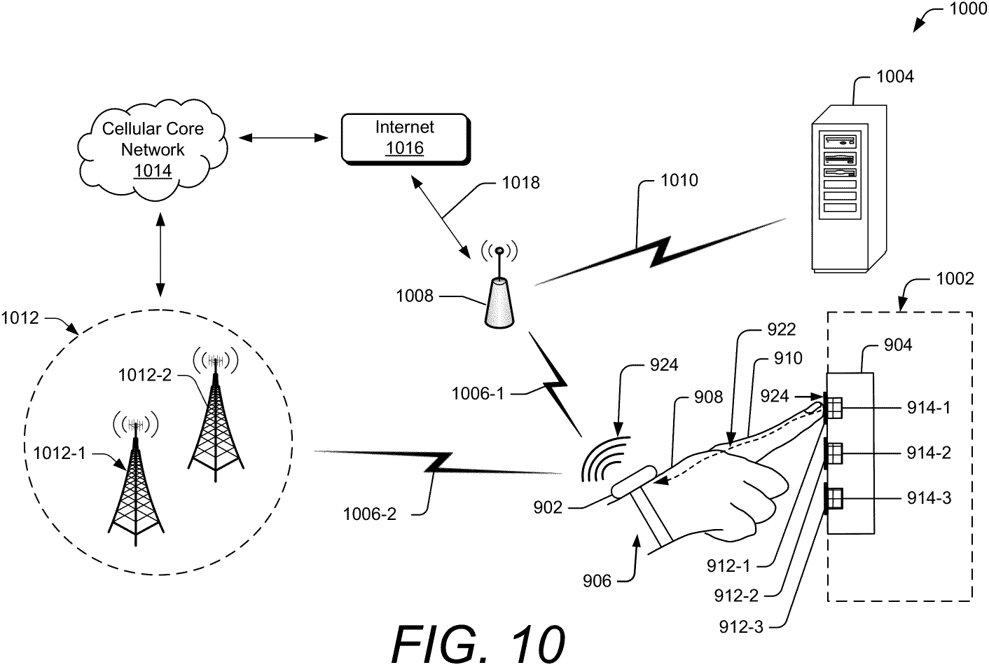

FIG. 10 illustrates another example environment 1000 in which communication between a computing device (smartwatch 902), a peripheral input device 904 of an automated teller machine 1002, and a server 1004 using a human transmission channel for at least portions can be implemented in accordance with one or more implementations. As illustrated, a physical medium associated with a user, including a wrist 906 of the user’s hand 908, is in contact with the smartwatch 902. In addition, a finger 910 of the user’s hand 908, is in contact with at least one contact surface 924 of a push button 912-1. In this particular example, the peripheral input device 904 is a keypad associated with (e.g., attached on, coupled to) of the automated teller machine 1002. Further, the server 1006 is a server at a financial institution (e.g., a bank). It is to be appreciated that FIG. 10 illustrates and is described as having a server 1006, but in other examples the server 1006 may be implemented, without limitation, as any of a variety of computing devices (e.g., computing device 202).

In the example illustrated in FIG. 10, the peripheral input device 1004 is electrically unpowered. The peripheral input device 1004 neither receives electrical power from an external source, nor has electrical components (e.g., one or more batteries) configured to electrically power components therein. In such a configuration, the peripheral input device 904 may utilize the compressive force of the pressing action applied by the user to generate the ultrasonic signal 922. For example, a user may press push button 912-1 with their finger 910. The compressive force induced by the pressing action on the push button 912-1 causes the push button 912-1 to depress from the elevated state to the depressed state. Pressing the push button 912-1 to the depressed state activates the ultrasonic transducer 914-1. For example, pressing the push button 912-1 to the depressed state causes piezoelectric elements in the ultrasonic transducer 914-1 to mechanically deform and, as a result, produce an electric charge. The ultrasonic transducer 914-1 may use the electric charge to produce the ultrasonic signal 922.

The ultrasonic signal 922 includes data corresponding to a value or identity of the push button 912-1. The resultant ultrasonic signal 922 produced by the user pressing the push button 912-1 includes data corresponding to the number one. The smartwatch 902 receives the ultrasonic signal 922 using the ultrasonic sensor (not illustrated), causing the ultrasonic sensor to produce the first electrical signal (e.g., first electrical signal 410). In so doing, the peripheral input device 904 and the smartwatch 902 may be in acoustic communication with one another, utilizing the user as the transmission channel.

Upon receiving the ultrasonic signal 922 and generating the first electrical signal, the processor in the smartwatch 902 implements steps to transmit the first electrical signal using electromagnetic waves 924 (e.g., radiofrequency (RF) communication). FIG. 10 illustrates the smartwatch 902 configured to electromagnetic waves 924 using one or more wireless connections 1006. In other implementations, the smartwatch 902 can transmit the first electrical signal using wired connections. As illustrated, the wireless connections may include a Wireless Local Area Network (WLAN) connection 1006-1 and a wireless link 1006-2. In an example, the smartwatch 1002 uses the WLAN connection 1006-1 to connect to a WLAN Access Point 1008 (WLAN AP 1008), which is connected to the server 1004 through a WLAN connection 1010. Through the WLAN connection 1006-1 to the WLAN AP 1008, the smartwatch 902 can transmit the first electrical signal to the server 1006. In another example, the smartwatch 902 uses the wireless link 1006-2 to connect to a cellular core network through one or more base stations 1012 (e.g., base station 1012-1, base station 1012-2). The cellular core network 1014 may be connected to, or have access to, the internet 1016. The WLAN AP 1008 can be connected to, or have access to, the internet 1016 through an interface 1018. In another example, the smartwatch 902 can broadcast the first electrical signal to be received by one or more receiving devices (e.g., WLAN AP 1008, server 1004) without having an established wireless connection (e.g., wireless linking, wireless pairing) with the one or more receiving devices. Through such connections, the smartwatch 902 can transmit the first electrical signal to the server 1004.

After the server 1004 receives the first electrical signal, the server 1004 can analyze the first electrical signal (e.g., verify a PIN) and instruct the automated teller machine to perform actions, including perform a cash withdrawal by dispensing money, deny the cash withdrawal, receive a cash or check deposit, call for assistance, and so forth. Through such a technique, no prior pairing needs to be established between the smartwatch 902 and the peripheral input device 904. Further, a peripheral input device 1004 can be a passive component, having no processor and being electrically unpowered.

### CONCLUSION

Although aspects of device communications using a human transmission channel have been described in language specific to features and/or methods, the subject of the appended claims is not necessarily limited to the specific features or methods described. Rather, the specific features and methods are disclosed as example implementations of device communications using a human transmission channel, and other equivalent features and methods are intended to be within the scope of the appended claims. Further, various aspects are described, and it is to be appreciated that each described aspect can be implemented independently or in connection with one or more other described aspects.

What is claimed is:

1. A system comprising:
a computing device, the computing device having:
a first housing having a first exterior surface and a first opposing interior surface;
an ultrasonic sensor disposed within the first housing adjacent to the first opposing interior surface and configured to convert an ultrasonic signal to a first electrical signal, the ultrasonic signal received by the ultrasonic sensor through acoustic communication with the first exterior surface;
a transmitter disposed within the first housing and operably coupled to the ultrasonic sensor, the transmitter having:
an oscillator configured to generate radiofrequency alternating current at a transmitting frequency and produce a carrier signal;
a modulator configured to receive and modulate the carrier signal by imposing the first electrical signal on the carrier signal, producing a modulated carrier signal; and
an antenna configured to receive the modulated carrier signal and convert the modulated carrier signal to produce electromagnetic waves; and
a power supply disposed within the first housing, the power supply configured to distribute electrical energy to the ultrasonic sensor and the transmitter; and
a peripheral input device configured to be in acoustic communication with the computing device, the peripheral input device having:
a second housing having a contact surface configured to be in contact with a second physical medium associated with the user; and
a plurality of ultrasonic transducers positioned within the second housing, a respective ultrasonic transducer of the plurality of ultrasonic transducers configured to, when activated, produce a vibration effective to generate an ultrasonic signal that:
is different from another ultrasonic signal generated by at least one other ultrasonic transducer of the plurality of ultrasonic transducers; and
is transmissible through the contact surface and the second physical medium associated with the user for receipt by the computing device to cause the computing device to wirelessly transmit the electromagnetic waves to a remote device associated with the peripheral input devices.

2. The system as described in claim 1, wherein at least a portion of the first physical medium associated with the user is in contact with at least a portion of the second physical medium associated with the user.

3. The system as described in claim 1, wherein:
the first physical medium associated with the user is a wrist of the user;
the second physical medium associated with the user is a finger of the user;
the computing device is a smartwatch;
the peripheral input device is a remote controller having multiple push buttons each having a corresponding contact surface; and
the remote device is a television or a speaker.

4. The system as described in claim 3, wherein a compressive force applied by the finger to the corresponding contact surface of one push button of the multiple push buttons causes the one push button to depress and activate the respective ultrasonic transducer of the plurality of ultrasonic transducers effective to generate the ultrasonic signal, which is transmissible through the corresponding contact surface of the one push button and the finger into the wrist for receipt by the smartwatch.

5. The system as described in claim 4, wherein the generated ultrasonic signal corresponds to a command to adjust a volume at the remote device.

6. The system as described in claim 5, wherein:
the ultrasonic sensor in the smartwatch is configured to:
receive the ultrasonic signal; and
generate the first electrical signal based on the ultrasonic signal; and
the smartwatch is configured to convert and broadcast the first electrical signal as electromagnetic waves for receipt by a remote device.

7. The system as described in claim 6, wherein the television is configured to:
receive the electromagnetic waves; and
convert the electromagnetic waves to the third electrical signal, the third electrical signal including information indicating an identity or value of the one push button;
execute one or more commands associated with the identity or value of the one push button.

8. The system as described in claim 1, wherein:
the first physical medium associated with the user is a wrist of the hand;
the computing device is a smartwatch;
the second physical medium associated with the user is a glove covering an epidermis of a hand;
the peripheral input device is an automated teller machine having multiple push buttons each with a corresponding contact surface; and
the remote device is a server associated with the automated teller machine.

9. The system as described in claim 8, wherein a compressive force applied by the hand covered by the glove to the corresponding contact surface of one push button of the multiple push buttons causes the one push button to depress and activate the respective ultrasonic transducer of the plurality of ultrasonic transducers effective to generate the ultrasonic signal, which is transmissible through the corresponding contact surface of the one push button and the glove into the hand and the wrist for receipt by the smartwatch.

10. The system as described in claim 9, wherein the generated ultrasonic signal corresponds to a numerical value or an alphanumeric value.

11. The system as described in claim 10, wherein:
the ultrasonic sensor in the smartwatch is configured to:
receive the ultrasonic signal; and
generate the first electrical signal based on the ultrasonic signal; and
the smartwatch is configured to convert and broadcast the first electrical signal as electromagnetic waves for receipt by a remote device.

12. The system as described in claim 11, wherein the server is configured to:
receive the electromagnetic waves; and
convert the electromagnetic waves to the third electrical signal, the third electrical signal including information indicating an identity or value of the one push button;
execute one or more commands based on the identity or value of the one push button.

13. The system as described in claim 1, wherein:
the first physical medium associated with the user is a first hand;
the computing device is a smartphone;
the second physical medium associated with the user is a finger of a second hand; and
the peripheral input device is a door keypad having multiple push buttons each with a corresponding contact surface.

14. The system as described in claim 13, wherein a compressive force applied by the finger of the second hand to the corresponding contact surface of one push button of the multiple push buttons causes the one push button to depress and activate the respective ultrasonic transducer of the plurality of ultrasonic transducers effective to generate the ultrasonic signal, which is transmissible through the corresponding contact surface of the one push button and the finger of the second hand into a body of the user to the first hand for receipt by the smartphone.

15. The system as described in claim 1, further comprising the remote device configured to be in wireless communication with the computing device, the remote device including:
a receiver configured to receive the electromagnetic waves from the computing device and convert the electromagnetic waves to a third electrical signal; and
a processor configured to process the third electrical signal and execute commands responsive to the processing.

16. The system as described in claim 15, wherein the computing device and the remote device are wirelessly unpaired.

17. The system as described in claim 16, wherein the electromagnetic waves include encoded device data or encrypted device data.

18. The system as described in claim 1, wherein the respective ultrasonic transducer configured to generate the ultrasonic signal responsive to activation by a compressive force applied by the second physical medium associated with the user.

19. The system as described in claim 1, wherein the peripheral input device is electrically unpowered.

20. The system as described in claim 1, wherein the first exterior surface is configured to receive the ultrasonic signal through a first physical medium associated with a user, the first physical medium in physical contact with the first exterior surface.
